(19) United States
(12) Patent Application Publication
(10) Pub. No.: US 2009/0040295 A1
(43) Pub. Date: Feb. 12, 2009

(54) METHOD AND APPARATUS FOR REPRODUCING STEREOSCOPIC IMAGE USING DEPTH CONTROL

(75) Inventors: Jae-phil KOO, Seoul (KR); Jae-seung KIM, Yongin-si (KR); Yong-tae KIM, Seoul (KR); Dae-sik KIM, Suwon-si (KR); Sang-hyoun KIM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/129,227

(22) Filed: May 29, 2008

Related U.S. Application Data
(60) Provisional application No. 60/954,102, filed on Aug. 6, 2007.

(30) Foreign Application Priority Data
Sep. 28, 2007 (KR) 10-2007-0098358

(51) Int. Cl. H04N 13/00

(52) U.S. Cl. 348/42; 348/E13.001

(57) ABSTRACT

A method and apparatus for reproducing a stereoscopic image are provided. The method includes generating information about parallax between a left-eye image and a right-eye image of objects included in the stereoscopic image based on a stereo camera parameter of the stereoscopic image, controlling the depth of the objects in the stereoscopic image based on the generated information, and reproducing the stereoscopic image based on the controlled depth. Accordingly, the stereoscopic image can be reproduced while minimizing the eye fatigue of a viewer.

### CROSS-REFERENCE TO RELATED PATENT APPLICATIONS

This application claims priority from Korean Patent Application No. 10-2007-0098358, filed on Sep. 28, 2007 in the Korean Intellectual Property Office, and U.S. Provisional Application No. 60/954,102, filed on Aug. 6, 2007 in the U.S. Patent and Trademark Office, the disclosures of which are incorporated herein in their entirety by reference.

### BACKGROUND OF THE INVENTION

1. Field of the Invention

Apparatuses and methods consistent with the present invention relate to reproducing a stereoscopic image, and more particularly, to reproducing a stereoscopic image by controlling the depth of objects included in the stereoscopic image, which can minimize eye fatigue.

2. Description of the Related Art

A primary factor for experiencing a three-dimensional (3D) effect is the spatial difference between images generated on the right and left retinas, because a left eye and a right eye look at a single object from different directions. In order to feel this spatial difference when viewing a display device with a two-dimensional (2D) plane, different images, i.e. a stereoscopic image, can be displayed for the right and left eyes. Accordingly, a viewer can feel like he/she is looking at a 3D image.

The viewer may wear polarized glasses in order to view a 3D image by dividing the 3D image into two separate images viewed using the left and right eyes. Alternatively, the viewer may install a lenticular screen in the display device in order to view a 3D image.

However, when the viewer views such an artificial 3D image for a long time, the eyes of the viewer may become fatigued, and blurred vision and headaches may be caused.

FIGS. 1A and 1B are diagrams illustrating a related art stereoscopic image.

FIGS. 1A and 1B illustrate parallax between images observed by a left-eye camera 110 and a right-eye camera 120, when left and right sides of objects in a world coordinate system are observed by different cameras. In FIGS. 1A and 1B, a 3D object in the world coordinate system is reproduced as a stereoscopic image by using a computer graphic acceleration library, such as DirectX. The left-eye camera 110 illustrated in FIG. 1A corresponds to a left eye of a viewer viewing the stereoscopic image, and the right-eye camera 120 illustrated in FIG. 1A corresponds to a right eye of the viewer.

An image 160 illustrated in FIG. 1B is an image observed by the left-eye camera 110, and an image 170 illustrated in FIG. 1B is an image observed by the right-eye camera 120. Comparing the images 160 and 170, disparities 180 and 190 are generated in objects 130 and 150, while no disparities occur in an object 140 located in the middle of the image.

The disparities 180 and 190 of the objects 130 and 150 differ based on an offset between the left-eye camera 110 and the right-eye camera 120 and a convergence angle formed by optical axes of the left-eye camera 110 and the right-eye camera 120. Generally, the disparities 180 and 190 increase as the offset between the left-eye camera 110 and the right-eye camera 120 increases.

The depth of objects is generated by such disparities, and a 3D effect of a stereoscopic image is formed due to the depth. However, when the disparities increase, a viewer may become fatigued due to the spatial difference in the eyes. Accordingly, a method of reproducing a stereoscopic image while minimizing fatigue induced in a viewer by suitably controlling the depths of objects of the stereoscopic image is required.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Exemplary embodiments of the present invention provide a method and apparatus for reproducing a stereoscopic image by controlling the depth of objects.

Exemplary embodiments of the present invention also provide a computer readable recording medium having recorded thereon a program for executing the method.

According to an aspect of the present invention, there is provided a method of reproducing a stereoscopic image. The method includes generating information about parallax between a left-eye image and a right-eye image of objects included in the stereoscopic image based on a stereo camera parameter of the stereoscopic image; controlling a depth of the objects in the stereoscopic image based on the generated information; and reproducing the stereoscopic image based on the controlled depth.

The information may be about a difference in locations of the objects in the left-eye image and the right-eye image.

The generating of the information may include calculating locations of the objects in the left-eye image based on the stereo camera parameter; calculating locations of the objects in the right-eye image based on the stereo camera parameter; and calculating a disparity of each object based on the calculated locations in the right-eye and left-eye images.

The controlling of the depth of the objects may include controlling the stereo camera parameter so that a size of the disparity of each object is not greater than a first threshold value.

The controlling of the depth of the objects may further include controlling the stereo camera parameter so that the size of the disparity of some objects is not greater than a second threshold value, wherein the second threshold value may be lower than the first threshold value.

According to another aspect of the present invention, there is provided an apparatus for reproducing a stereoscopic image. The apparatus includes an information generator, which generates information about parallax between a left-eye image and a right-eye image of objects included in the stereoscopic image based on a stereo camera parameter of the stereoscopic image; a depth controller, which controls a depth of the objects in the stereoscopic image based on the generated information; and a reproducer, which reproduces the stereoscopic image based on the controlled depth.

The information generator may calculate locations of the objects in the left-eye image based on the stereo camera parameter, calculate locations of the objects in the right-eye image based on the stereo camera parameter, and calculate a disparity of each object based on the calculated locations in the right-eye and left-eye images.

The depth controller may control the stereo camera parameter so that a size of the disparity of each object is not greater than a first threshold value.

The depth controller may control the stereo camera parameter so that the size of the disparity of some objects is not greater than a second threshold value, wherein the second threshold value may be lower than the first threshold value.

According to another aspect of the present invention, there is provided a computer readable recording medium having recorded thereon a program for executing the above method.

### BRIEF DESCRIPTION OF THE DRAWINGS

The above and other aspects of the present invention will become more apparent by describing in detail exemplary embodiments thereof with reference to the attached drawings in which:

FIGS. 1A and 1B are diagrams illustrating a related art stereoscopic image;

FIG. 2 is a diagram illustrating an apparatus for reproducing a stereoscopic image according to an exemplary embodiment of the present invention;

FIG. 3 illustrates disparity histograms according to an exemplary embodiment of the present invention;

FIG. 4 is a flowchart illustrating a method of reproducing a stereoscopic image according to an exemplary embodiment of the present invention; and

FIG. 5 is a diagram illustrating a user interface according to an exemplary embodiment of the present invention.

### DETAILED DESCRIPTION OF EXEMPLARY EMBODIMENTS OF THE INVENTION

Hereinafter, the present invention will be described more fully with reference to the accompanying drawings, in which exemplary embodiments of the invention are shown.

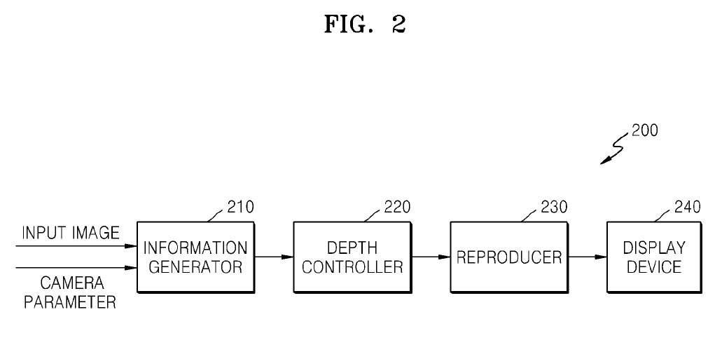

FIG. 2 is a diagram illustrating an apparatus 200 for reproducing a stereoscopic image according to an exemplary embodiment of the present invention.

Referring to FIG. 2, the apparatus 200 includes an information generator 210, a depth controller 220, a reproducer 230, and a display device 240. In FIG. 2, the apparatus 200 receives a stereoscopic image through a computer graphic acceleration library, such as DirectX or OpenGL. The apparatus 200 reproduces the stereoscopic image by receiving information about objects included in the stereoscopic image and about a camera parameter from the computer graphic acceleration library. The information about the objects may include information about the locations of the objects in a world coordinate system, and the information about the camera parameter may include information about a camera parameter of a left-eye camera and an offset between the left-eye camera and a right-eye camera.

The information generator 210 generates information about parallax of the objects in a left-eye image and a right-eye image. The locations of the objects in the left-eye image and the right-eye image are calculated using the information about the locations of the objects in a world coordinate system and the information about the camera parameter. Then, the information about the parallax is generated based on the calculated locations.

The parallax is binocular parallax generated in the stereoscopic image, and the information about the parallax is generated by calculating disparities of the locations of each object in the left-eye image and of the locations of each object in the right-eye image. The following equations show methods of calculating the disparities. When a location vector (4×1) of an n-th object, included in the stereoscopic image, in the world coordinate system is Xn, a location vector when the n-th object is projected to the left-eye image is xnl(3×1), a location vector when the n-th object is projected to the right-eye image is xnr(3×1), P1 is a left-eye camera parameter (3×4), and P2 is a right-eye camera parameter (3×4), xnl and xnr can be calculated as Equation 1 below.

xnl=P1×Xn, xnr=P2×Xn Equation 1

Xn, which is the location of the n-th object in the world coordinate system, is a matrix of coordinates in a 3D space, and P1 and P2 are matrices of the left-eye camera parameter and the right-eye camera parameter, respectively. P2 can be calculated based on P1. In other words, the right-eye camera parameter can be generated by applying information about the offset and a convergence angle to the left-eye camera parameter. Here, the convergence angle is an angle formed by optical axes of the left-eye and right-eye cameras.

When the locations of all the objects in the left-eye and right-eye images are determined, a disparity dn can be calculated by using Equation 2 below.

dn=xnr−xnl Equation 2

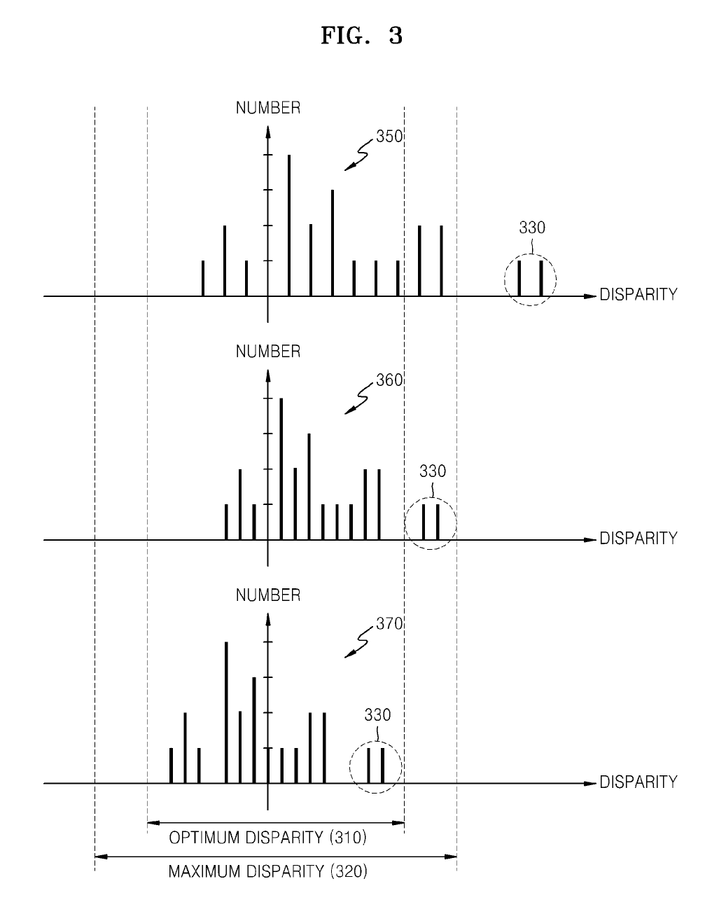

When disparities of the objects are calculated, a disparity histogram can be generated based on the result of the calculation. This will now be described in detail with reference to FIG. 3.

FIG. 3 illustrates disparity histograms according to an exemplary embodiment of the present invention.

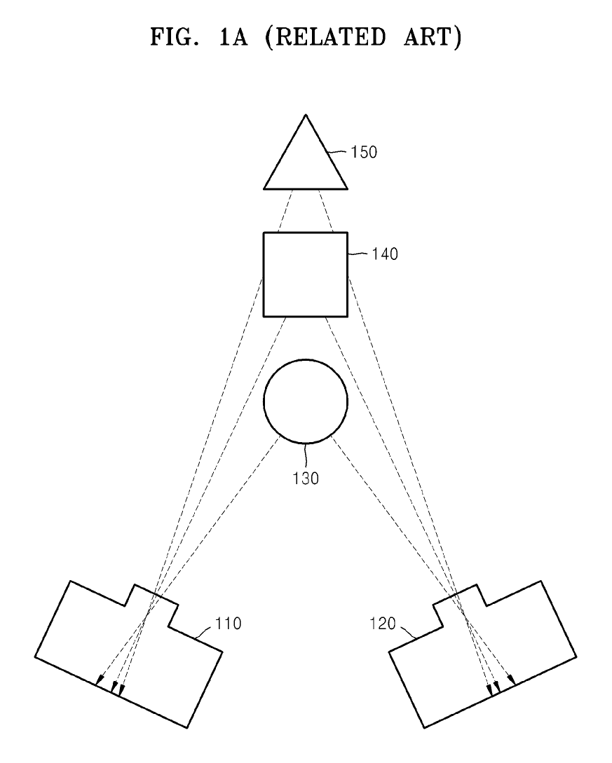

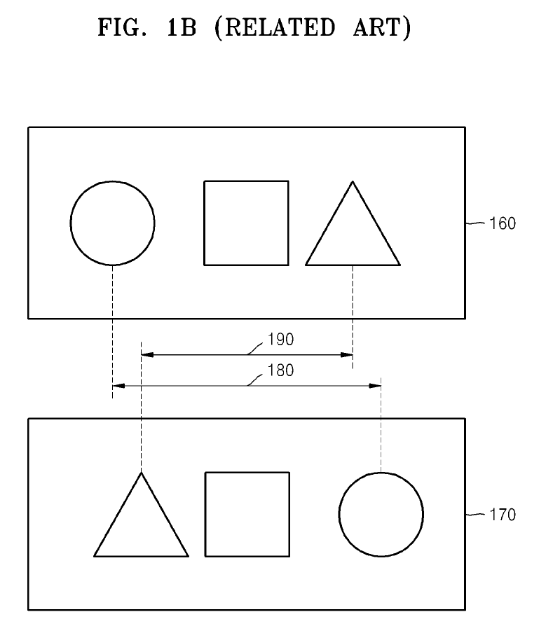

The information generator 210 may generate disparity histograms of the objects in the left-eye and right-eye images as the information about the parallax. As described above with reference to FIGS. 1A and 1B, disparities of each object included in the stereoscopic image differ based on the locations in the world coordinate system. Accordingly, a disparity histogram such as a first histogram 350 illustrated in FIG. 3 can be generated based on the disparities of the objects.

Referring to FIG. 2, the depth controller 320 controls the depth of the objects based on the information about the parallax generated by the information generator 310. The depth can be controlled by controlling at least one of the offset and the convergence angle between the left-eye and right-eye cameras.

Referring back to FIG. 3, when the first histogram 350 is generated, the depth controller 220 controls the depth of the objects so that the disparities of the objects are included in a maximum disparity 320, as shown in a second histogram 360. By controlling the depth of the objects so that the disparities of the objects are included in a predetermined range, eye fatigue can be reduced.

In other words, by controlling the offset between the left-eye and right-eye cameras, the size of the disparities of all the objects can be reduced to be smaller than the size of the disparities illustrated in the first histogram 350.

The depth controller 220 may control the camera parameter so that the disparities of the objects are included in an optimum disparity 310 as illustrated in a third histogram 370. As illustrated in the second histogram 360, the size of the disparities of all the objects can be reduced, and then the camera parameter may be controlled by shifting the disparities in a negative direction so that the disparities of all the objects are included in the optimum disparity 310.

Specifically, the disparities are shifted so that a disparity 330 of an object of interest is included in the optimum disparity 310. The object of interest is an object closely observed by the viewer, and the disparity 330 is generally located on the right side of the first, second, and third disparity histograms 350, 360, and 370. As an object is near to the viewer, a disparity of the object has a large positive value on the first, second, and third disparity histograms 350, 360, and 370, and thus the disparity of the object is located on the right side of the first, second, and third disparity histograms 350, 360, and 370. Also, it is likely that an object closer to the viewer is an object of interest that is closely observed by the viewer. Accordingly, the camera parameter is controlled so that the disparity 330 of the object of interest is included in the optimum disparity 310.

The optimum disparity 310 is a disparity wherein eye fatigue is minimized. A disparity histogram, wherein the disparities are shifted in a negative direction, such as the third histogram 370, can be obtained by controlling the convergence angle between the left-eye and right-eye cameras.

The optimum disparity 310 and the maximum disparity 320 can be experimentally determined based on the size and type of a display device, and are not limited to certain values. For example, the optimum disparity 310 and the maximum disparity 320 can be determined based on the range of the optimum binocular parallax and the range of the maximum binocular parallax of a 3DC safety guideline of the 3D Consortium.

Referring back to FIG. 2, when the depth controller 220 controls the depth of the objects by controlling the camera parameter, the reproducer 230 reproduces the stereoscopic image based on the controlled depth. The stereoscopic image is rendered based on the controlled camera parameter, i.e. the offset and convergence angle between the left-eye and right-eye cameras. The left-eye camera parameter is fixed, and then the controlled right-eye parameter is generated based on the controlled offset and convergence angle. Then, the stereoscopic image is reproduced based on the left-eye camera parameter and the controlled right-eye camera parameter.

The display device 240 receives and displays the stereoscopic image rendered in the reproducer 230.

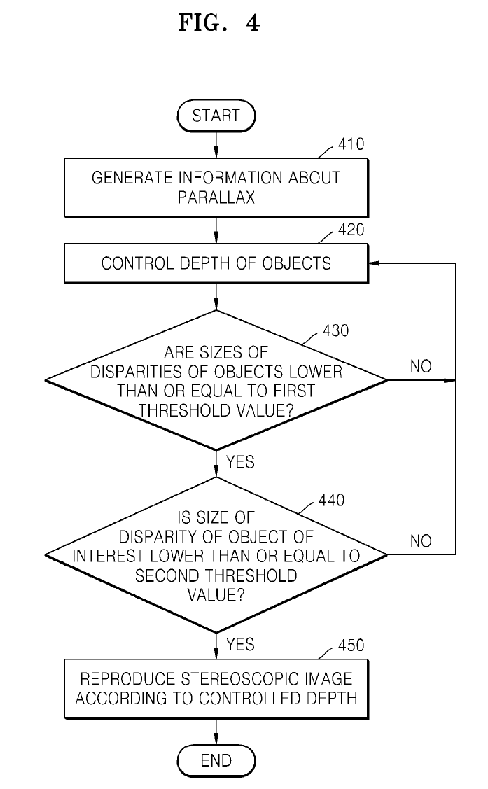

FIG. 4 is a flowchart illustrating a method of reproducing a stereoscopic image according to an exemplary embodiment of the present invention.

Referring to FIG. 4, the apparatus 200 of FIG. 2 generates information about the parallax of objects included in the stereoscopic image in a left-eye image and a right-eye image in operation 410. The information about the parallax is generated by calculating the locations of the objects in the left-eye image and the right-eye image using a camera parameter, and calculating disparities of the objects based on the result of calculating the locations.

In operation 420, the apparatus 200 controls the depth of the objects based on the information about the parallax generated in operation 410. The depth of the objects is controlled by controlling the camera parameter based on information about the disparities of the objects in the left-eye and right-eye images. The depth of the objects is controlled by controlling at least one of an offset and a convergence angle between a left-eye camera and a right-eye camera from among the camera parameters.

In operation 430, the apparatus 200 calculates the disparities of the objects based on the depth of the objects controlled in operation 420, and determines whether the size of the calculated disparity is lower than or equal to a first threshold value. Here, the first threshold value may be the maximum disparity 320 described with reference to FIG. 3.

When it is determined that the sizes of the disparities of the objects are higher than the first threshold value, the depth is controlled again in operation 420. If it is determined that the sizes of disparities of all objects are lower than the first threshold value, it is determined whether the size of a disparity of an object of interest is lower than or equal to a second threshold value in operation 440. Here, the second threshold value is lower than the first threshold value, and may be the optimum disparity 310 described with reference to FIG. 3.

When it is determined that the size of the disparity of the object of interest is lower than or equal to the second threshold value in operation 440, the apparatus 200 reproduces the stereoscopic image based on the controlled depth. The stereoscopic image is reproduced based on the controlled camera parameter, i.e. the offset and convergence angle between the left-eye and right-eye cameras.

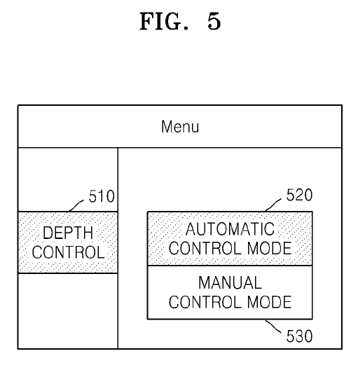

FIG. 5 is a diagram illustrating a user interface according to an exemplary embodiment of the present invention.

FIG. 5 illustrates the user interface, which displays a depth control mode provided to a viewer through a display device in order to reproduce a stereoscopic image according to the method of exemplary embodiments of the present invention.

In a related art technology, the viewer has to directly control the depth of objects through a manual control mode 530. However, in exemplary embodiments of the present invention, the user interface is provided so that the viewer can select an automatic control mode 520, which generates the first, second, and third disparity histograms 350, 360, and 370 of the objects included in the stereoscopic image based on the information about parallax, and automatically controls the depth of the objects based on the generated first, second, and third disparity histograms 350, 360, and 370.

When the viewer selects the automatic control mode 520, the stereoscopic image is reproduced by automatically controlling the depth according to the method of exemplary embodiments of the present invention.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

According to exemplary embodiments of the present invention, a stereoscopic image can be reproduced while minimizing eye fatigue of a viewer, since the depth of objects included in the stereoscopic image can be automatically controlled based on disparities of the objects in a left-eye image and a right-eye image.

While the present invention has been particularly shown and described with reference to exemplary embodiments thereof, it will be understood by those of ordinary skill in the art that various changes in form and details may be made therein without departing from the spirit and scope of the present invention as defined by the following claims and their legal equivalents.

What is claimed is:

1. A method of reproducing a stereoscopic image, comprising:
generating information about parallax between a left-eye image and a right-eye image of objects included in the stereoscopic image based on a stereo camera parameter of the stereoscopic image;
controlling a depth of the objects in the stereoscopic image based on the generated information; and
reproducing the stereoscopic image based on the controlled depth.

2. The method of claim 1, wherein the generated information comprises information about a difference in locations of the objects in the left-eye image and the right-eye image.

3. The method of claim 2, wherein the generating of the information comprises:
calculating locations of the objects in the left-eye image based on the stereo camera parameter;
calculating locations of the objects in the right-eye image based on the stereo camera parameter; and
calculating a disparity of each of objects based on the calculated locations in the right-eye and left-eye images.

4. The method of claim 3, wherein the controlling of the depth of the objects comprises controlling the stereo camera parameter so that a size of the disparity of each of objects is not greater than a first threshold value.

5. The method of claim 4, wherein the controlling of the depth of the objects further comprises controlling the stereo camera parameter so that the size of the disparity of at least one of the objects is not greater than a second threshold value,
wherein the second threshold value is lower than the first threshold value.

6. The method of claim 4, wherein the controlling of the depth of the objects further comprises controlling an offset between a camera for the left-eye image and a camera for the right-eye image.

7. The method of claim 6, wherein the stereoscopic image is reproduced based on a parameter of the camera for the left-eye image and a parameter of the camera for the right-eye image, after the offset is controlled.

8. The method of claim 4, wherein the controlling of the depth of the objects further comprises controlling a convergence angle of a camera for the left-eye image and a camera for the right-eye image.

9. An apparatus for reproducing a stereoscopic image, comprising:
an information generator, which generates information about parallax between a left-eye image and a right-eye image of objects included in the stereoscopic image based on a stereo camera parameter of the stereoscopic image;
a depth controller, which controls a depth of the objects in the stereoscopic image based on the generated information; and
a reproducer, which reproduces the stereoscopic image based on the controlled depth.

10. The apparatus of claim 9, wherein the generated information comprises information about a difference in locations of the objects in the left-eye image and the right-eye image.

11. The apparatus of claim 10, wherein the information generator calculates locations of the objects in the left-eye image based on the stereo camera parameter, calculates locations of the objects in the right-eye image based on the stereo camera parameter, and calculates a disparity of each of objects based on the calculated locations in the right-eye and left-eye images.

12. The apparatus of claim 11, wherein the depth controller controls the stereo camera parameter so that a size of the disparity of each of objects is not greater than a first threshold value.

13. The apparatus of claim 12, wherein the depth controller controls the stereo camera parameter so that the size of the disparity of at least one of the objects is not greater than a second threshold value,
wherein the second threshold value is lower than the first threshold value.

14. The apparatus of claim 11, wherein the depth controller controls an offset between a camera for the left-eye image and a camera for the right-eye image.

15. The apparatus of claim 14, wherein the reproducer reproduces the stereoscopic image based on a parameter of the camera for the left-eye image and a parameter of the camera for the right-eye image, after the offset is controlled.

16. The apparatus of claim 11, wherein the depth controller controls a convergence angle of a camera for the left-eye image and a camera for the right-eye image.

17. A computer readable recording medium having recorded thereon a program for executing the method of claim 1.
